(19) United States
(12) Patent Application Publication
(10) Pub. No.: US 2014/0139711 A1
(43) Pub. Date: May 22, 2014

(54) Image Pickup Lens And Image Pickup Device

(71) Applicant: Eigo Sano, Hino-shi (JP)

(72) Inventor: Eigo Sano, Hino-shi (JP)

(21) Appl. No.: 14/232,821

(22) PCT Filed: Jul. 11, 2012
(86) PCT No.: PCT/JP2012/067749

§ 371 Date: Jan. 14, 2014

(30) Foreign Application Priority Data
Jul. 14, 2011 (JP) 2011-156060

(51) Int. Cl. G02B 13/00; H04N 5/335

(52) U.S. Cl. CPC G02B 13/002; H04N 5/335
USPC 348/294; 359/708

(57) ABSTRACT

An image pickup lens 10 includes a first lens L1, a second lens L2, and a third lens L3. An image pickup surface I of a solid-state image sensor 51 is curved into the shape of a shallow concave spherical surface. By forming an image side surface 3b of the third lens L3, which is the lens nearest to the image side, into an aspherical shape, it is possible to make a curvature of field suitable to the curved image pickup surface I while securing excellent telecentric characteristics. The above image pickup lens 10 satisfies conditional expression (1) where THID is a thickness of an outermost periphery PA of the lens L3 nearest to the image side along an optical axis direction AX and THIC is a thickness of the lens L3 nearest to the image side on the optical axis AX.

### TECHNICAL FIELD

The present invention relates to a compact image pickup lens for forming an image on a solid-state image sensor having a curved image pickup surface, and an image pickup device including the same.

### BACKGROUND ART

Recently, a compact image pickup device using a solid-state image sensor, such as a CCD (Charge Coupled Device) type image sensor and a CMOS (Complementary Metal Oxide Semiconductor) type image sensor, is mounted on a mobile terminal, such as a mobile telephone and a PDA (Personal Digital Assistant), and further, on a notebook personal computer, etc., and it is made possible to transmit image information, not only audio information, to and from a remote site.

For the solid-state image sensor used in such an image pickup device, a reduction in pixel size is in progress and an attempt is made to increase the number of pixels and to reduce the size of the image sensor. Further, it is made possible to curve the image pickup surface (for example, see Patent Literatures 1 and 2) and an image pickup lens optimum to such an image sensor, compact and high-performance is demanded.

In Patent Literature 1, by curving the solid-state image sensor into the shape of a polynomial surface, the curvature of field and distortion aberration that are caused by the lens are corrected in a balanced manner, and thus a compact image pickup device having a high resolution is provided. However, the solid-state image sensor has the CIF size (352 pixels×288 pixels) and the image pickup lens has a single-lens configuration, and therefore, the chromatic aberration is not corrected sufficiently and it is not possible to expect to obtain an image pickup device of high performance by using a solid-state image sensor having a more number of pixels.

In Patent Literature 2, with a two-lens configuration, improvement of performance and a reduction in size to a certain degree are achieved, but, the back focus is long and in some lenses, the image side surface of the lens nearest to the image to side tilts toward the image side on the periphery, and therefore, it is difficult to achieve a sufficient reduction in size of the image pickup lens and the image pickup device while securing a clearance between the image pickup lens and the solid-state image sensor.

In Patent Literatures 3 to 5, image pickup lenses for the use in a compact camera and a lens-attached film unit or one-time use camera are disclosed. Among these, the image pickup lens in Patent Literature 3 has a curved image pickup surface, a photographing angle of view of about 70 degrees to 75 degrees, and a brightness of about F10, and the image pickup lenses in Patent Literatures 4 and 5 each have a curved image pickup surface, a photographing angle of view of about 77 degrees, and a brightness of about F5.7 to F6.2. The lens configuration in Patent Literature 3 is a two-lens configuration including an aperture stop, a positive or negative first lens, and a positive second lens, and that in Patent Literatures 4 and 5 is the triplet and rear-diaphragm type lens including a positive first lens, a negative second lens, a positive third lens and an aperture stop.

However, the F-number of each of the image pickup lenses in Patent Literatures 3 to 5 is large or corresponds slow and if the F-number is attempted to be decreased or fast, it is not possible to obtain a sufficient performance, and the back focus is long, therefore, the image pickup lens and the image pickup device increase in size.

Further, Patent Literatures 3 to 5 handle the image pickup lens for a film camera. That is, an attempt to improve performance is made by curving the film surface (image pickup surface) in accordance with the curvature of field that is caused by the image pickup lens. However, because each image pickup lens is for an old-type camera that uses a roll film, the film surface forms a so-called cylindrical image pickup surface that curves only in the long-side direction of the image area or picture plane due to the structure of the camera. Because of this, an excellent performance can be obtained in the long-side direction of the image area, but, the image pickup surface remains a flat surface in the short-side direction of the image area or picture plane, and therefore, it is not possible to make an attempt to improve performance and further, there may be a case where a reduction in image quality is caused depending on the correction situation of the curvature of field. That is, by curving the image pickup surface only in the long-side direction as in Patent Literatures 3 to 5, it is difficult to obtain a high performance across the entire image area. Because of this, in general, the F-number is made slow or large and the focal depth is set great so that blurring in the planar direction is not conspicuous, and therefore, it has been difficult to decrease the F-number.

Further, those disclosed in Patent Literatures 3 to 5 are the image pickup lenses for the film camera as described previously, and therefore the principal ray incidence angle is not necessarily designed to be sufficiently small on the periphery of the image pickup surface. On the other hand, in the image pickup lens for forming a subject image on the photoelectric conversion unit of the solid-state image sensor, if the characteristics of the principal ray incidence angle of a pencil of rays that enters the image pickup surface, that is, the so-called telecentric characteristics, are degraded, the light beam enters the solid-state image sensor in the oblique direction and a phenomenon in which the substantial aperture efficiency is reduced (i.e., shading) is caused on the periphery of the image pickup surface, and therefore the quantity of light on the periphery runs short. Because of this, in general, the compact lens for the solid-state image sensor is designed so as to suppress small the angle of incidence of light rays incident on the image pickup surface by forming the image side surface of the lens nearest to the image side into an aspherical shape and causing the periphery of the lens nearest to the image side to have a positive refractive power. However, if the periphery has a positive refractive power, the lens tends to have a large ratio between the thickness at the center part of the lens and that on the periphery, that is, a so-called center-to-periphery thickness ratio, and there is a possibility that the formability is impaired if the center-to-periphery thickness ratio is large like this.

Patent Literature 3 describes that it is possible to apply the image pickup lens to an electronic still camera, not only to a film camera. However, the image pickup lens described in Patent Literature 3 has a large F-number of about F10, a long back focus, and a large size, and the telecentric characteristics thereof are not sufficiently excellent, and therefore, it can be thought that the application of the image pickup lens to a compact image pickup device using a solid-state image sensor is difficult.

### CITATION LIST

### Patent Literature

PTL 1: Japanese Patent Laid-Open No. 2004-356175
PTL 2: Japanese Patent Laid-Open No. 2004-118077
PTL 3: Japanese Patent Laid-Open No. 1996-334684
PTL 4: Japanese Patent Laid-Open No. 1996-68935
PTL 5: Japanese Patent Laid-Open No. 2000-292688,

### SUMMARY OF INVENTION

An object of the present invention is to provide an image pickup lens for forming an image on a solid-state image sensor having the curved image pickup surface, the image pickup lens being compact and high-performance, capable of suppressing shading, including lenses having excellent formability, and having a brightness or speed of about, for example, F2.8 to F4.

Another object of the present invention is to provide an image pickup device including the image pickup lens as described above.

In order to achieve the above-mentioned objects, the image pickup lens according to the present invention is an image pickup lens for forming a subject image on a solid-state image sensor, in which an image pickup surface of said solid-state image sensor is curved so as to tilt toward an object side in an arbitrary cross-section toward a periphery of an image area, the image pickup lens comprising two or more lenses, wherein the image pickup lens has an aperture stop in a position other than positions between a lens nearest to an image side and the solid-state image sensor, an image side surface of said lens nearest to the image side has an aspherical shape, and a conditional expression below is satisfied

0.80<THID/THIC<2.00 (1)

where

THID: a thickness of an outermost periphery of said lens nearest to the image side along an optical axis direction

THIC: a thickness on an optical axis of said lens nearest to the image side

The image pickup surface on which an image is formed by the image pickup lens of the present invention is supposed to be a curved surface curving so as to have curvatures in all the directions of 360° with the optical axis as a center, not a curved surface curving only in the long-side direction as in the conventional film camera.

Because the image pickup surface of the solid-state image sensor is curved, it is possible to achieve both a reduction in size and improvement of performance. When the image pickup surface is curved so as to be concave toward the image pickup lens side, it is advantageous in correction of the principal ray incidence angle of light beam that enters the image pickup surface, that is, in correction of so-called telecentric characteristics. That is, the principal ray incidence angle of light beam that enters the image pickup surface is smaller in the case where the image pickup surface is curved toward the image pickup lens side on the periphery than that in the case where the image pickup surface is flat, and therefore, it is possible to suppress the occurrence of shading without reducing the aperture efficiency even if the correction of telecentric characteristics is not performed sufficiently in the image pickup lens. Further, the correction of the curvature of field, distortion curvature, comatic aberration, etc., is made easy and a reduction in size is also enabled. Here, the present invention premises that the curved shape of the image pickup surface is such that the image pickup surface is curved not only in the long-side direction of the picture plane or image area but also in the short-side direction so as to tilt toward the object side toward the periphery of the picture plane or image area, but, the shape does not necessarily need to be a spherical shape and may be any surface shape that can be expressed by an arbitrary mathematical expression, such as an aspherical shape, a paraboloidal shape, and an XY polynomial surface shape, and by forming a shape that fits to the shape of the curvature of field caused by the lens system, it is made possible to improve performance across the entire image area.

The image pickup lens of the present invention includes two or more lenses and has an aperture stop in a position other than positions between the lens nearest to the image side and the solid-state image sensor, and the image side surface of the lens nearest to the image side has an aspherical shape. In the present invention, by using two or more lenses, an attempt is made to improve performance compared to that of a lens with a single-lens configuration. If the image pickup lens has a stop between the lens nearest to the image side and the solid-state image sensor, that is, a rear-diaphragm type, the angle of incidence on the image pickup surface becomes very large and it is no longer possible to perform correction only by curving the image pickup surface. Because of this, it is desirable to have the aperture stop between the constituent lenses (lens group) or on the side nearest to the object of the constituent to lenses (lens group). Further, by forming the image side surface of the lens nearest to image side into an aspherical shape, it is made possible to obtain the curvature of field that fits to the curved image pickup surface while securing excellent telecentric characteristics.

The conditional expression (1) is a conditional expression for appropriately setting a ratio between the thickness on the optical axis of the lens nearest to the image side and the thickness of the periphery. Here, the thickness of the periphery refers to the thickness in the direction along the principal ray of light beam that forms an image on the outermost part of the solid-state image sensor when the light ray passes through the lens nearest to the image side.

When the value of the conditional expression (1) is larger than the lower limit, it is possible to prevent the ratio between the thickness at the center part of the lens nearest to the image side and that of the periphery (so-called center-to-periphery thickness ratio) from becoming large and it is made possible to achieve excellent formability. Further, it is possible to form the lens nearest to the image side into the shape that tilts more toward the object side at a position more distant from the center toward the periphery, resulting in the same shape as that of the curved image pickup surface, and therefore, it is possible to secure a clearance between the lens nearest to the image side and the image pickup surface from the center up to the periphery. Furthermore, there is no longer a dead space between the constituent lens and the image pickup surface, and therefore, it is made easy to reduce the total length of the image pickup lens as a result.

On the other hand, when the value of the conditional expression (1) is smaller than the upper limit, it is possible to moderately maintain the action to refract the light ray on the periphery of the lens nearest to the image side toward the optical axis side and to improve the telecentric characteristics on the periphery.

From the above-described viewpoint, more desirably, the value of THID/THIC is within a range expressed by an expression below.

0.80<THID/THIC<1.80 (1)′

In a specific aspect of the present invention, in the above-mentioned image pickup lens, the image pickup surface satisfies a conditional expression below

0.05<SAGI/Y<0.50 (2)

where

SAGI: an amount of displacement of the image pickup surface in the optical axis direction at a maximum image height
Y: a maximum image height

The conditional expression (2) is a conditional expression for appropriately setting the amount of curvature of the image pickup surface. When the value is larger than the lower limit or the lower limit is surpassed, it is possible to moderately maintain the amount of curvature of the image pickup surface and an increase in burden of correcting the telecentric characteristics and curvature of field in the image pickup lens, and therefore, the Petzval sum does not become too small and it is possible to preferably correct the comatic aberration and chromatic aberration. On the other hand, when the upper limit is not surpassed, the amount of curvature of the image pickup surface does not become too large and it is possible to prevent excessive correction in which the curvature of field is made too large on the image pickup lens side. Further, the final surface of the image pickup lens and the image pickup surface are prevented from becoming too close and it is possible to sufficiently secure an air separation or distance for inserting a parallel flat plate, such as an infrared (IR) cut filter.

From the above-described viewpoint, more desirably, the value of SAGI/Y is within a range expressed by an expression below.

0.10<SAGI/Y<0.40 (2)′

In another aspect of the present invention, the image pickup surface has a spherical shape and satisfies a conditional expression below

−8.0<RI/Y<−1.0 (3)

where

RI: a radius of curvature of the image pickup surface
Y: a maximum image height

By forming the image pickup surface into a spherical shape, the image pickup surface does not have a complicated shape, and therefore, it is possible to reduce the level of difficulty of the manufacturing process of curving the image pickup surface.

The conditional expression (3) is a conditional expression for appropriately setting the amount of curvature of the image pickup surface. When the lower limit is surpassed, it is possible to moderately maintain the amount of curvature of the image pickup surface and it is possible to prevent an increase in burden to correct the telecentric characteristics and curvature of field in the image pickup lens, and therefore, the Petzval sum does not become too small and the comatic aberration and chromatic aberration can be corrected preferably. On the other hand, when the upper limit is not surpassed, it is possible to prevent excessive correction in which the curvature of field is made too large on the image pickup lens side by suppressing the amount of curvature of the image pickup lens from becoming too large. Further, the final surface of the image pickup lens and the image pickup surface are prevented from becoming too close and it is possible to sufficiently secure an air separation or distance for inserting a parallel flat plate, such as an IR cut filter.

From the above-described viewpoint, more desirably, the value of RI/Y is within a range expressed by an expression below.

−7.0<RI/Y<−1.5 (3)′

In still another aspect of the present invention, a conditional expression below is satisfied

0.30<SAGI/SAGL<10.50 (4)

where

SAGI: an amount of displacement of the image pickup surface in the optical axis direction at the maximum image height

SAGL: an amount of displacement of the image side surface of the lens nearest to the image side in the optical axis direction in a maximum effective aperture.

The conditional expression (4) is a conditional expression for appropriately setting a ratio between the amount of displacement of the image pickup surface at the maximum image height and the amount of displacement in the maximum effective aperture area of the image side surface of the lens nearest to the image side through which the light beam that forms an image at the maximum image height passes. When the lower limit is surpassed, the amount of displacement of the image side surface of the lens nearest to the image side on the periphery does not become too large more than necessary and the positive power on the periphery of the image side surface does not become too strong, and therefore, it is possible to suppress the distortion aberration and somatic aberration. On the other hand, when the upper limit is not surpassed, it is made possible to sufficiently secure a clearance between the periphery of the lens nearest to the image side and the periphery of the image pickup surface.

From the above-mentioned viewpoint, more desirably, the value of SAGL is within a range expressed by an expression below.

0.40<SAGI/SAGL<10.40 (4)′

In still another aspect of the present invention, the lens nearest to the image side has a negative refractive power. When the lens nearest to the image side has a negative refractive power, it is possible to form the image pickup lens into a telephoto type, which is advantageous for reduction in the total length of the image pickup lens.

In still another aspect of the present invention, a conditional expression below is satisfied

0.15<fb/f<1.30 (5)

where

fb: a back focus of the image pickup lens
f: a focal length of an entire system of the image pickup lens.

The conditional expression (5) is a conditional expression for appropriately setting the back focus of the lens system. When the lower limit is surpassed, the lens nearest to the image side and the image pickup surface no longer come too close to each other and it is possible co secure a space for inserting a parallel flat plate, such as an optical low pass filter and an IR cut filter. On the other hand, when the upper limit is not surpassed, the back focus does not become too large more than necessary and as a result, it is possible to reduce the total length of the image pickup lens. Here, the back focus refers to a distance on the optical axis between the lens nearest to the image side and the image pickup surface on the assumption that the parallel flat plate part is regarded as an air-equivalent distance when a parallel flat plate, such as an optical low pass filter, an IR cut filter, and a seal glass of a solid-state image sensor package is disposed between the lens nearest to the image side and the image pickup surface.

From the above-described viewpoint, more desirably, the value of fb/f is within a range expressed by an expression below.

0.15<fb/f<1.20 (5)′

In still another aspect of the present invention, the aperture stop is disposed on an object side of the two or more lenses constituting an image pickup lens. By disposing the aperture stop on the side nearest to the object of the constituent lenses or the lens group, it is possible to make the exit pupil position distant from the image pickup surface, and therefore, it is made possible to secure the excellent telecentric characteristics.

In still another aspect of the present invention, the aperture stop is disposed between a first lens on the side nearest to the object and a second lens adjacent to the image side of the first lens of the two or more lenses constituting the image pickup lens. By disposing the aperture stop between the first lens and the second lens, the angle of refraction of a peripheral marginal light ray passing through the object side surface of the first lens does not become too large and it is possible to achieve both a reduction in size of the image pickup lens and excellent aberration correction.

In order to achieve the above-mentioned objects, the image pickup device according to the present invention includes the image pickup lens and the solid-state image sensor described above. By using the image pickup lens of the present invention, it is possible to obtain an image pickup device that is compact and high-performance, and capable suppressing shading.

### BRIEF DESCRIPTION OF DRAWINGS

FIG. 1 is a diagram for explaining an image pickup device of an embodiment of the present invention.

FIG. 2 is a sectional view of an image pickup lens of Example 1.

FIGS. 3A to 3E are aberration diagrams of the image pickup lens of Example 1.

FIG. 4 is a sectional view of an image pickup lens of Example 2.

FIGS. 5A to 5E are aberration diagrams of the image pickup lens of Example 2.

FIG. 6 is a sectional view of an image pickup lens of Example 3.

FIGS. 7A to 7E are aberration diagrams of the image pickup lens of Example 3.

FIG. 8 is a sectional view of an image pickup lens of Example 4.

FIGS. 9A to 9E are aberration diagrams of the image pickup lens of Example 4.

FIG. 10 is a sectional view of an image pickup lens of Example 5.

FIGS. 11A to 11E are aberration diagrams of the image pickup lens of Example 5.

FIG. 12 is a sectional view of an image pickup lens of Example 6.

FIGS. 13A to 13E are aberration diagrams of the image pickup lens of Example 6.

FIG. 14 is a sectional view of an image pickup lens of Example 7.

FIGS. 15A to 15E are aberration diagrams of the image pickup lens of Example 7.

### DESCRIPTION OF EMBODIMENTS

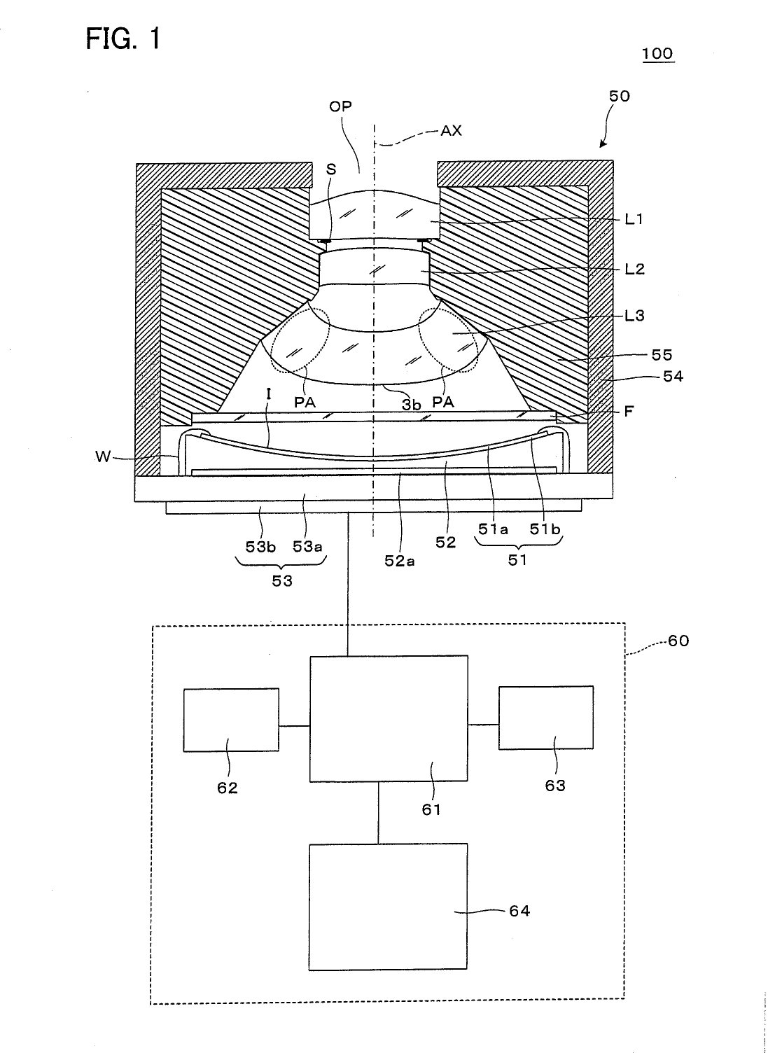

FIG. 1 is a sectional view showing an image pickup device 100 according to an embodiment. The image pickup device 100 includes an imaging unit 50 for forming an image signal and a processing unit 60 that exhibits functions as the image pickup device 100 by appropriately operating the imaging unit 50.

The imaging unit 50 includes an image pickup lens 10 forming a subject image, a solid-state image sensor 51, which is a CMOS type image sensor, and detects a subject image formed by the image pickup lens 10, a support 52 keeping the solid-state image sensor 51 in a curved state, a substrate 53 supporting the support 52 from behind and provided with a wire etc., and a light blocking casing 54 having an opening OP to allow a light beam from the object side to enter, and these are formed integrally.

The image pickup lens 10 includes a first lens L1, an aperture stop S, a second lens L2, and a third lens L3 in order from the object side, for example.

The solid-state image sensor 51 has a photoelectric conversion unit 51a as a light receiving unit and a signal processing circuit 51b is formed on the periphery thereof. The photoelectric conversion unit 51a has an image pickup surface I on which pixels (photoelectric conversion elements) are disposed two-dimensionally. The signal processing circuit Sib is configured by, for example, a drive circuit unit sequentially driving each pixel to obtain a signal charge, an A/D conversion unit converting each signal charge into a digital signal, etc. The solid-state image sensor 51 is not limited to the above-described CMOS type image sensor but may be one to which, for example, a CCD etc. is applied.

The support 52 is formed by a hard material and has a role to maintain and fix the solid-state image sensor 51 into a concave shape recessed symmetrically around an optical axis AX. Because of this, in an arbitrary cross-section including the optical axis AX, the image pickup surface I of the solid-state image sensor 51 is in a curved state (specifically, a hemispherical concave surface) where the image pickup surface I tilts toward the image pickup lens 10 side so as to be headed to the optical axis AX at the center. It is possible to form a signal processing circuit 52a having a function to control the operation of the signal processing circuit 51b in the support 52.

The substrate 53 includes a main body part 53a supporting the support 52 and the casing 54 on one of the surface sides and a flexible printed substrate 53b one end of which is connected to the other surface side of the main body part 53a. The main body part 53a is connected with the solid-state image sensor 51 via a bonding wire Won the above-described one surface side and connected with the flexible printed substrate 53b on the above-described other surface side.

The flexible printed substrate 53b connects the main body part 53a and an external circuit (for example, a control circuit that an upper device mounting the imaging unit 50 has), not shown schematically, and makes it possible to receive the supply of a voltage and clock signal for driving the solid-state image sensor 51 from the external circuit and to output YUV and other digital pixel signals to the external circuit.

The casing 54 accommodates and holds the image pickup lens 10 assembled to a lens frame 55. The casing 54 is provided on the solid-state image sensor 51 side of the substrate 53 so as to cover the solid-state image sensor 51. That is, the backside of the casing 54 is opened widely so as to enclose the solid-state image sensor 51 and fixed on the peripheral edge of the main body part 53a and the surface side thereof is formed into the shape of a flange-attached cylinder having the predetermined sized opening OP. Inside the casing 54, a parallel flat plate F having the infrared cut function is fixed and disposed by being sandwiched between the main body of the image pickup lens 10 and the solid-state image sensor 51. The parallel flat plate F is supported by the lens frame 55 similarly to the main body of the image pickup lens 10.

The processing unit 60 includes a control unit 61, an input unit 62, a storage unit 63, and a display unit 64. The control unit 61 causes the imaging unit 50 to perform the imaging operation. The input unit 62 is a unit for receiving the operation of a user, the storage unit 63 is a unit for keeping information necessary for the operation of the image pickup device 100, image data acquired by the imaging unit 50, etc., and the display unit 64 is a unit for displaying information to be presented to a user, photographed images, etc. It is possible for the control unit 61 to perform various kinds of image processing on, for example, image data obtained by the imaging unit 50.

Although detailed explanation is omitted, the specific functions of the processing unit 60 are appropriately adjusted according to which of a digital camera, mobile telephone, PDA (Personal Digital Assistant), etc., the image pickup device 100 is assembled to.

Hereinafter, with reference to FIG. 1, the image pickup lens 10 of the embodiment is explained. The image pickup lens 10 illustrated in FIG. 1 has the same configuration as that of an image pickup lens 11 of Example 1, to be described later.

As shown in FIG. 1, the image pickup lens 10 of the embodiment causes the solid-state image sensor 51 to form a subject image and includes two or more lenses, specifically, the first lens L1, the second lens L2, and the third lens L3. The image pickup lens 10 includes the parallel flat plate F as an optical element having substantially no power. The image pickup surface I of the solid-state image sensor 51 is curved into the shape of a shallow concave spherical surface and forms a rotational surface having symmetry around the optical axis AX. The image pickup lens 10 has the aperture stop S in a position other than positions between the third lens L3, which is the lens nearest to the image side, and the solid-state image sensor 51, specifically, between the first lens L1 and the second lens L2. An image side surface 3b of the third lens L3, which is the lens nearest to the image side of the image pickup lens 10, has an aspherical shape.

Because the image pickup surface I of the solid-state image sensor 51 to which the image light from the image pickup lens 10 cause to enter is curved, it is possible to achieve both a reduction in size and improvement of performance of the image pickup lens 10 etc. Specifically, because the periphery of the image pickup surface I curves toward the image pickup lens 10 side, the principal ray incidence angle of the light beam that enters the image pickup surface I becomes small, and therefore, it is possible to suppress the occurrence of shading without reducing the aperture efficiency, even if the telecentric characteristics are not corrected sufficiently in the image pickup lens 10. Further, the correction of the curvature of field, distortion aberration, comatic aberration, etc., is made easy and a reduction in size of the image pickup lens 10 etc. is also enabled.

The image pickup lens 10 aims at improvement of performance by using two or more lenses, specifically, the three lenses L1, L2, and L3. Further, by providing the aperture stop S between the first lens L1 and the second lens L2, the angle of incidence of the light beam incident on the image pickup surface I is prevented from becoming too large. Furthermore, by forming the image side surface 3b of the third lens L3 etc., which is the lens nearest to the image side, into an aspherical shape, it is possible to obtain the curvature of field suitable to the curved image pickup surface I while securing the excellent telecentric characteristics.

The above image pickup lens 10 satisfies the already-explained conditional expression (1)

0.80<THID/THIC<2.0 (1)

where THID is the thickness of an outermost periphery PA of the lens L3 nearest to the image side along the optical axis direction and THIC is the thickness of the lens L3 nearest to the image side on the optical axis AX.

The above-mentioned conditional expression (1) is a conditional expression for appropriately setting the ratio between the thickness of the third lens L3, which is the lens nearest to the image side on the optical axis AX, and the thickness of the outermost periphery PA. Here, the thickness of the outermost periphery PA refers to the thickness in the optical axis direction along the principal ray of the light beam that forms an image on the outermost part of the solid-state image sensor when the light ray passes through the lens nearest to the image side.

When the value of the conditional expression (1) surpasses the lower limit, it is possible to reduce the ratio of thickness between the center part of the third lens L3, which is the lens nearest to the image side, and the outermost periphery PA, that is, the so-called center-to-periphery thickness ratio and it is possible to realize excellent formability of the third lend L3. Further, it is possible to give the third lend L3 the shape that tilts more toward the object side at a position more distant from the center of the third lens L3, which is the lens nearest to the image side, toward the periphery, and to make the shape the same as the curved image pickup surface I, and therefore, it is possible to secure a clearance between the third lens L3 and the image pickup surface I from the center up to the periphery. Furthermore, there is no longer a dead space between the third lens L3 etc. and the image pickup surface I, and therefore, a reduction in the total length of the image pickup lens 10 is achieved as a result.

On the other hand, when the value of the conditional expression (1) does not surpass the upper limit, it is possible to moderately maintain the action to refract the light rays at the outermost periphery PA of the third lens L3, which is the lens nearest to the image side, toward the optical axis AX side and to make excellent the telecentric characteristics on the outermost periphery PA.

More desirably, the image pickup lens 10 satisfies expression (1)′ below, which further limits or restricts the above-mentioned conditional expression (1).

0.80<THID/THIC<1.80 (1)′

The image pickup lens 10 of the embodiment satisfies the already-explained conditional expression (2) besides the above-mentioned conditional expression (1)

0.05<SAGI/Y<0.50 (2)

where SAGI is the amount of displacement of the image pickup surface I in the optical axis direction at the maximum image height and Y is the maximum image height.

More desirably, the image pickup lens 10 satisfies expression (2)′ below, which further limits or restricts the above-mentioned conditional expression (2).

0.10<SAGI/Y<0.40 (2)′

The image pickup lens 10 of the embodiment satisfies the already-explained conditional expression (3) besides the above-mentioned conditional expression (1)

−8.0<RI/Y<−1.0 (3)

where RI is the radius of curvature of the image pickup surface I.

More desirably, the image pickup lens 10 satisfies expression (3)′ below, which further limits or restricts the above-mentioned conditional expression (3).

−7.0<RI/Y<−1.5 (3)′

The image pickup lens 10 of the embodiment satisfies the already-explained conditional expression (4) besides the above-mentioned conditional expression (1)

0.30<SAGI/SAGL<10.50 (4)

where SAGI is the amount of displacement of the image pickup surface I in the optical axis direction at the maximum image height and SAGL is the amount of displacement of an image side surface 3a of the third lens L3 in the optical axis direction in the maximum effective aperture area.

More desirably, the image pickup lens 10 satisfies expression (4)′ below, which further limits or restricts the above-mentioned conditional expression (4).

0.40<SAGI/SAGL<10.40 (4)′

The image pickup lens 10 of the embodiment satisfies the already-explained conditional expression (5) besides the above-mentioned conditional expression (1)

0.15<fb/f<1.30 (5)

where fb is a back focus of the image pickup lens 10 and f is a focal length of an entire system of the image pickup lens 10.

More desirably, the image pickup lens 10 satisfies expression (5)′ below, which further limits or restricts the above-mentioned conditional expression (5).

0.15<fb/f<1.20 (5)′

### EXAMPLE

Hereinafter, Examples of the image pickup lens of the present invention are shown. Symbols used in each Example are as follows.

f: focal length of an entire system of the image pickup lens

fB: back focus

F: F-number

2Y: diagonal length of the image pickup surface of a solid-state image sensor

ENTP: entrance pupil position (distance from the first surface to the entrance pupil position)

EXTP: exit pupil position (distance from the image pickup surface to the exit pupil position)

H1: front principal point position (distance from the first surface to the front principal point position)

H2: back principal point position (distance from the final surface to the back principal point position)

R: radius of curvature

D: axial surface separation or distance

Nd: refractive index for d line of a lens material

νd: Abbe number of a lens material

In each Example, a surface whose surface number is followed by “*” is a surface having an aspherical shape and the shape of an aspherical surface is expressed by “Formula 1” below where the vertex of the surface is taken to be the origin, the X axis is taken to be in the optical axis direction, and a height in the direction perpendicular to the optical axis is taken to be h.

$$X = \frac{{h}^{2} \text{/} R}{1 + \sqrt{1 - ( 1 + K ) {h}^{2} \text{/} {R}^{2}}} + \sum {A}_{i} {h}^{l} \qquad [ Formula 1 ]$$

where

Ai: an aspherical surface coefficient of i order

R: a radius of curvature

K: a conic constant

### Example 1

General specifications of an image pickup lens of Example 1 are as follows.

f=2.38 mm
fB=0.76 mm

### F=2.4

### 2Y=3.5 mm

### ENTP=0.41 mm

### EXTP=−1.07 mm

### H1=−0.31 mm

### H2=−1.63 mm

Lens surface data of Example 1 is shown in Table 1 below. “STOP” means the aperture stop S and “IMAG” means the image pickup surface I.

TABLE 1

| Surface | | | | | Effective |
|---|---|---|---|---|---|
| number | R (mm) | D (mm) | Nd | vd | radius (mm) |
| 1* | 1.161 | 0.49 | 1.54470 | 56.2 | 0.66 |
| 2* | 4.222 | 0.03 | | | 0.47 |
| 3 | infinity | 0.07 | | | 0.45 |
| (STOP) | | | | | |
| 4* | 3.788 | 0.37 | 1.54470 | 56.2 | 0.48 |
| 5* | −6.689 | 0.48 | | | 0.55 |
| 6* | −1.910 | 0.54 | 1.63470 | 23.9 | 0.68 |
| 7* | −5.978 | 0.74 | | | 1.15 |
| 8 | −6.354 | | | | |
| (IMAG) | | | | | |

Aspherical surface coefficients of the lens surfaces of Example
1 are as follows.
First surface

| | | |
|---|---|---|
| K = −0.25843E+01, | A4 = 0.45319E−01, | A6 = −0.20599E+00, |
| A8 = −0.68537E+00, | A10 = 0.55464E+00 | |

Second surface

| | | |
|---|---|---|
| K = −0.30000E+02, | A4 = −0.21862E+00, | A6 = −0.77470E+00, |
| A8 = 0.21693E+01, | A10 = −0.14820E+01 | |

Fourth surface

| | | |
|---|---|---|
| K = 0.15140E+02, | A4 = 0.32865E−01, | A6 = −0.31885E+00, |
| A8 = 0.40411E+01, | A10 = −0.38145E+01 | |

Fifth surface

| | | |
|---|---|---|
| K = −0.30000E+02, | A4 = 0.11738E+00, | A6 = 0.87909E+00, |
| A8 = −0.25596E+01, | A10 = 0.94636E+01 | |

Sixth surface

| | | |
|---|---|---|
| K = −0.64696E+00, | A4 = −0.57777E+00, | A6 = 0.63229E+00, |
| A8 = −0.51960E+01, | A10 = 0.14167E+02, | A12 = −0.20902E+02 |

Seventh surface

| | | |
|---|---|---|
| K = 0.25667E+02, | A4 = −0.11673E+00, | A6 = −0.31995E−01, |
| A8 = 0.71497E−01, | A10 = −0.51129E−01, | A12 = −0.17970E−03 |

In this table and the following tables (including lens data in Tables), a power of 10 (for example, 2.5×10⁻⁰²) is expressed by using E (for example, 2.5E-02)

Single lens data of Example 1 is shown in Table 2 below.

TABLE 2

| | | Focal length |
|---|---|---|
| LENS | First surface | (mm) |
| 1 | 1 | 2.784 |
| 2 | 4 | 4.497 |
| 3 | 6 | −4.660 |

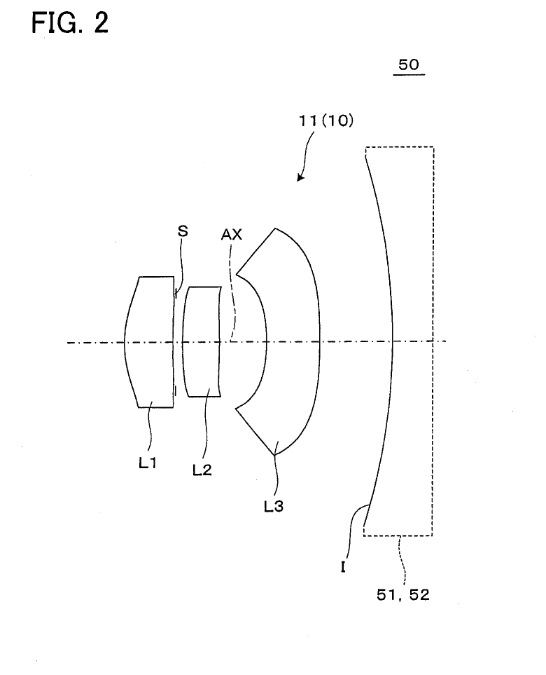

FIG. 2 is a sectional view of the image pickup lens 11 of Example 1 or the imaging unit 50. The image pickup lens 11 includes the first meniscus lens L1 having a positive refractive power and convex toward the object side, the second biconvex lens L2 having a positive refractive power, and the third meniscus lens L3 having a negative refractive power and convex toward the image side. All the lenses L1 to L3 are formed of plastic materials. Between the first lens L1 and the second lens L2, the aperture stop S is disposed. In the present example, the image pickup surface I has a spherical shape. It is possible to dispose the parallel flat plate F shown in FIG. 1 between the convex surface of the third lens L3 and the concave image pickup surface I.

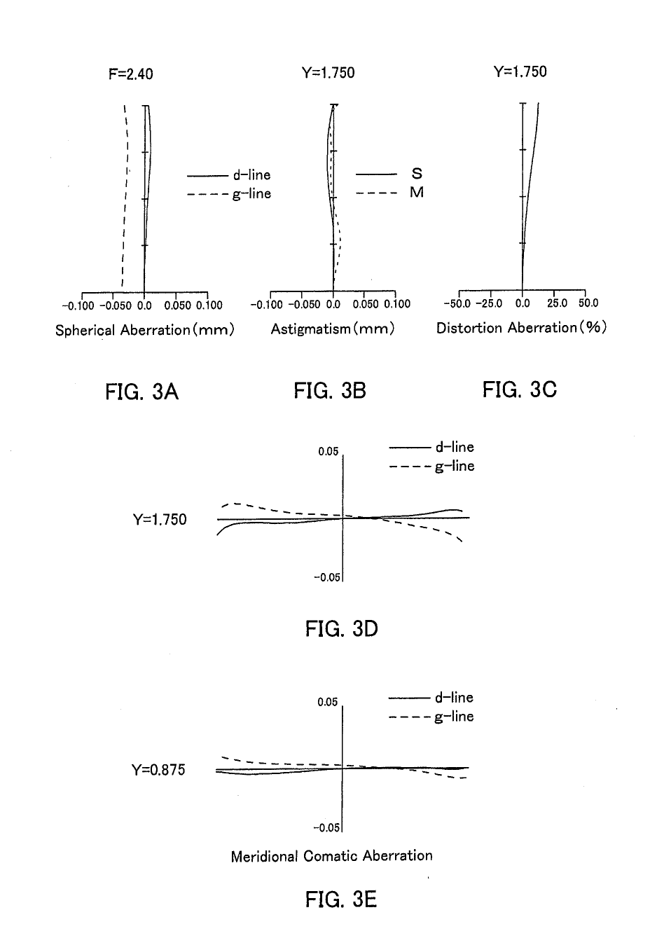

FIGS. 3A to 3C show aberration diagrams (spherical aberration, astigmatism, and distortion aberration) of the image pickup lens 11 of Example i and FIGS. 3D and 3E show the meridional comatic aberration of the image pickup lens 11 of Example 1.

### Example 2

General specifications of an image pickup lens of Example 2 are as follows.

f=2.39 mm
fB=0.6 mm

### F=2.4

### 2Y=3.5 mm

### ENTP=0.44 mm

### EXTP=−1.26 mm

### H1=−0.23 mm

### H2=−1.78 mm

Lens surface data of Example 2 is shown in Table 3 below.

TABLE 3

| Surface | | | | | Effective |
|---|---|---|---|---|---|
| number | R (mm) | D (mm) | Nd | vd | radius (mm) |
| 1* | 1.191 | 0.48 | 1.54470 | 56.2 | 0.68 |
| 2* | 2.315 | 0.05 | | | 0.46 |
| 3 | infinity | 0.07 | | | 0.44 |
| (STOP) | | | | | |
| 4* | 2.015 | 0.45 | 1.54470 | 56.2 | 0.50 |
| 5* | −5.096 | 0.38 | | | 0.60 |
| 6* | −2.010 | 0.90 | 1.63470 | 23.9 | 0.65 |
| 7* | −9.570 | 0.60 | | | 1.32 |
| 8 | −6.969 | | | | |
| (IMAG) | | | | | |

Aspherical surface coefficients of the lens surfaces of Example
2 are as follow.
First surface

| | | |
|---|---|---|
| K = −0.23484E+01, | A4 = 0.62251E−01, | A6 = −0.11697E+00, |
| A8 = −0.39497E+00, | A10 = 0.19543E+00 | |

Second surface

| | | |
|---|---|---|
| K = −0.41745E+01, | A4 = −0.11680E+00, | A6 = −0.65316E+00, |
| A8 = 0.91685E+00, | A10 = −0.75003E+00 | |

Fourth surface

| | | |
|---|---|---|
| K = 0.45036E+01, | A4 = −0.67987E−01, | A6 = −0.42921E+00, |
| A8 = 0.97000E+00, | A10 = −0.76215E+00 | |

Fifth surface

| | | |
|---|---|---|
| K = −0.30000E+02, | A4 = −0.93881E−01, | A6 = 0.38334E+00, |
| A8 = −0.22038E+01, | A10 = 0.35467E+01 | |

Sixth surface

| | | |
|---|---|---|
| K = −0.39257E+01, | A4 = −0.55727E+00, | A6 = 0.50788E+00, |
| A8 = −0.59853E+01, | A10 = 0.16419E+02, | A12 = −0.25388E+02 |

Seventh surface

| | | |
|---|---|---|
| K = −0.30000E+02, | A4 = −0.22108E−01, | A6 = −0.11785E+00, |
| A8 = 0.11587E+00, | A10 = −0.66301E−01, | A12 = 0.14855E−01 |

Single lens data of Example 2 is shown in Table 4 below.

TABLE 4

| | | Focal length |
|---|---|---|
| LENS | First surface | (mm) |
| 1 | 1 | 3.918 |
| 2 | 4 | 2.712 |
| 3 | 6 | −4.203 |

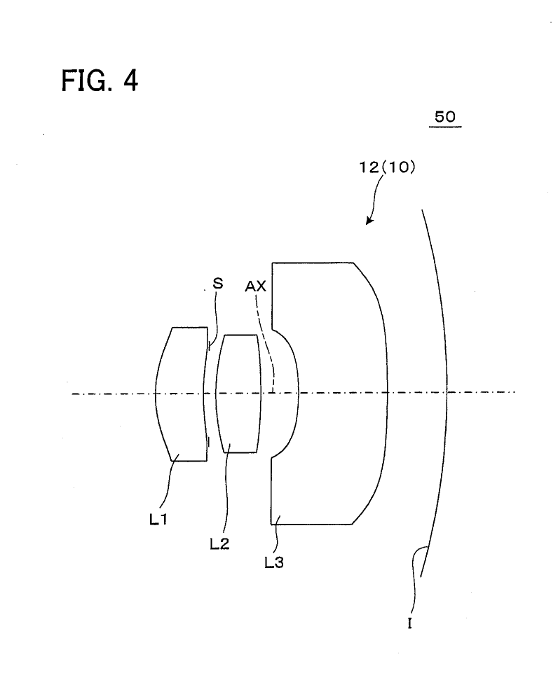

FIG. 4 is a sectional view of an image pickup lens 12 of Example 2 or the imaging unit 50. The image pickup lens 12 includes the first meniscus lens L1 having a positive refractive power and convex toward the object side, the second biconvex lens L2 having a positive refractive power, and the third meniscus lens L3 having a negative refractive power and convex toward the image side. All the lenses L1 to L3 are formed of plastic materials. Between the first lens L1 and the second lens L2, the aperture stop S is disposed. In the present example, the image pickup surface I has a spherical shape. It is possible to dispose the parallel flat plate F shown in FIG. 1 between the convex surface of the third lens L3 and the concave image pickup surface I.

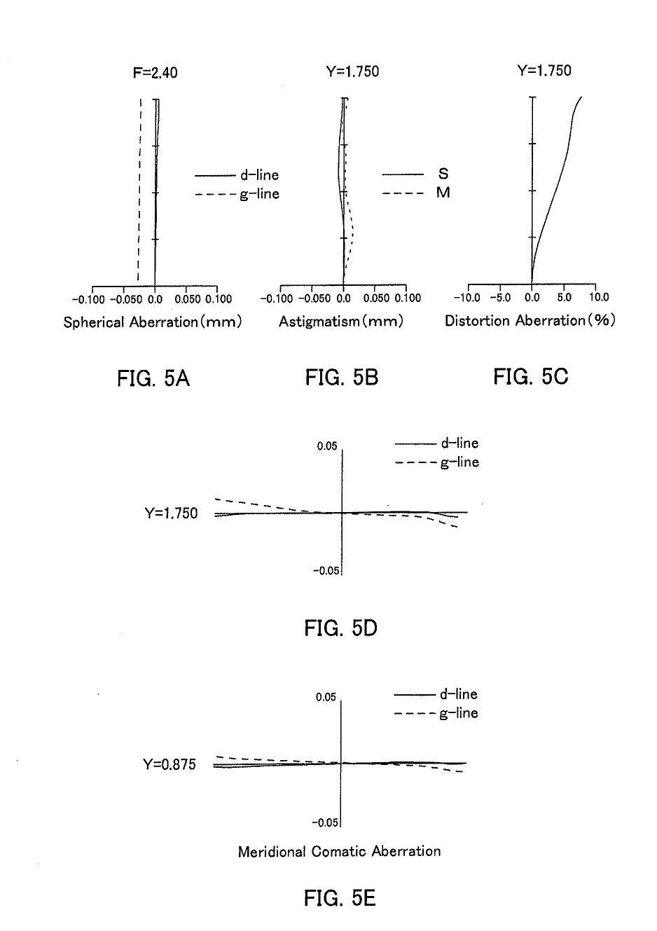

FIGS. 5A to 5C show aberration diagrams (spherical aberration, astigmatism, and distortion aberration) of the image pickup lens 12 of Example 2 and FIGS. 5D and 5E show the meridional comatic aberration of the image pickup lens 12 of Example 2.

### Example 3

General specifications of an image pickup lens of Example 3 are as follows.

f=3 mm
fB=1.73 mm

### F=2.8

### 2Y=4.536 mm

### ENTP=0 mm

### EXTP=−1.71 mm

### H1=0.38 mm

### H2=−1.27 mm

Lens surface data of Example 3 is shown in Table 5 below.

TABLE 5

| Surface | | | | | Effective |
|---|---|---|---|---|---|
| number | R (mm) | D (mm) | Nd | vd | radius (mm) |
| 1 | infinity | −0.06 | | | 0.53 |
| STOP | | | | | |
| 2* | 1.218 | 0.65 | 1.54470 | 56.2 | 0.56 |
| 3* | 2.107 | 0.60 | | | 0.65 |
| 4* | −801.679 | 0.61 | 1.54470 | 56.2 | 1.03 |
| 5* | −3.248 | 1.72 | | | 1.33 |
| 6 | −6.893 | | | | |
| (IMAG) | | | | | |

Aspherical surface coefficients of the lens surfaces of Example
3 are as follow.
Second surface

| | | |
|---|---|---|
| K = −0.83589E−01, | A4 = 0.63341E−02, | A6 = 0.17877E+00, |
| A8 = −0.62056E+00, | A10 = 0.16155E+01, | A12 = −0.18854E+01 |

Third surface

| | | |
|---|---|---|
| K = 0.43853E+01, | A4 = 0.72575E−01, | A6 = −0.65234E−02, |
| A8 = −0.10661E+00, | A10 = 0.80743E+00, | A12 = −0.73994E+00 |

Fourth surface

| | | |
|---|---|---|
| K = −0.94483E+05, | A4 = 0.30860E−01, | A6 = −0.10667E+00, |
| A8 = 0.14926E+00, | A10 = −0.23616E+00, | A12 = 0.18440E+00, |
| A14 = −0.66932E−01 | | |

Fifth surface

| | | |
|---|---|---|
| K = −0.34691E+02, | A4 = −0.44080E−01, | A6 = 0.55225E−01, |
| A8 = −0.22438E−01, | A10 = −0.25165E−01, | A12 = 0.21006E−01, |
| A14 = −0.51705E−02 | | |

Single lens data of Example 3 is shown in Table 6 below.

TABLE 6

| | | Focal length |
|---|---|---|
| LENS | First surface | (mm) |
| 1 | 2 | 4.216 |
| 2 | 4 | 5.985 |

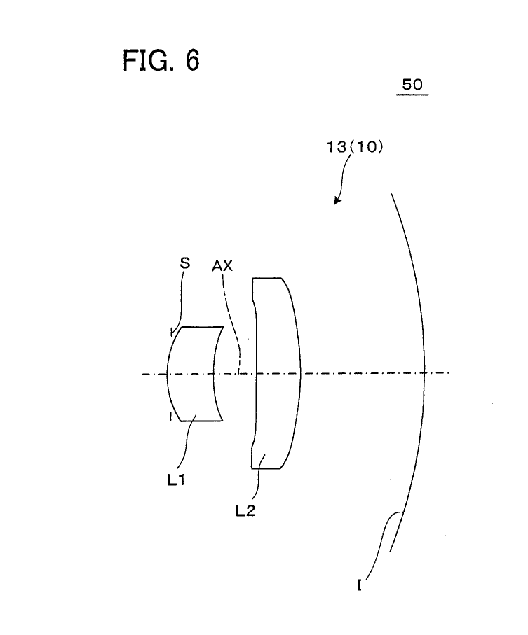

FIG. 6 is a sectional view of an image pickup lens 13 of Example 3 or the imaging unit 50. The image pickup lens 13 includes the first meniscus lens L1 having a positive refractive power and convex toward the object side and the second meniscus lens L2 having a positive refractive power and convex toward the image side. All the lenses L1 and L2 are formed of plastic materials. On the object side of the first lens L1, the aperture stop S is disposed. In the present example, the image pickup surface I has a spherical shape. It is possible to dispose the parallel flat plate F shown in FIG. 1 between the convex surface of the second lens L2 and the concave image pickup surface I.

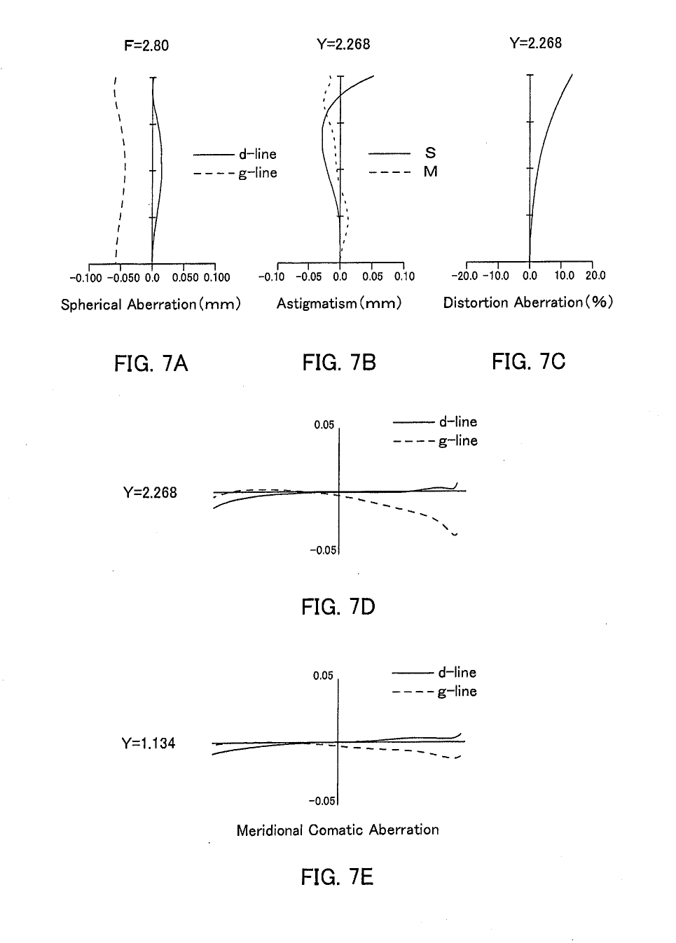

FIGS. 7A to 7C show aberration diagrams (spherical aberration, astigmatism, and distortion aberration) of the image pickup lens 13 of Example 3 and FIGS. 7D and 7E show the meridional comatic aberration of the image pickup lens 13 of Example 3.

### Example 4

General specifications of an image pickup lens of Example 4 are as follows.

f=4.68 mm
fB=1.03 mm

### F=2.88

### 2Y=6.973 mm

### ENTP=0 mm

### EXTP=−3.82 mm

### H1=0.16 mm

### H2=−3.65 mm

Lens surface data of Example 4 is shown in Table 7 below.

TABLE 7

| Surface | | | | | Effective |
|---|---|---|---|---|---|
| number | R (mm) | D(mm) | Nd | vd | radius (mm) |
| 1 | infinity | −0.01 | | | 0.81 |
| (STOP) | | | | | |
| 2* | 3.484 | 1.59 | 1.54470 | 56.2 | 0.85 |
| 3* | −4.706 | 0.06 | | | 1.30 |
| 4* | −7.921 | 0.40 | 1.63200 | 23.4 | 1.33 |
| 5* | 6.574 | 0.26 | | | 1.54 |
| 6* | 12.758 | 1.28 | 1.54470 | 56.2 | 1.77 |
| 7* | −5.217 | 0.81 | | | 1.98 |
| 8* | 3.523 | 0.73 | 1.54470 | 56.2 | 2.30 |
| 9* | 2.618 | 0.40 | | | 3.06 |
| 10 | infinity | 0.15 | 1.51630 | 64.1 | 3.47 |
| 11 | infinity | | | | 3.52 |
| 12 | −9.840 | | | | |
| (IMAG) | | | | | |

Aspherical surface coefficients of the lens surfaces of Example
4 are as follow.
Second surface

| | | |
|---|---|---|
| K = 0.26831E+00, | A4 = −0.49640E−02, | A6 = −0.35249E−02, |
| A8 = 0.41901E−02, | A10 = −0.30654E−02 | |

Third surface

| | | |
|---|---|---|
| K = 0.34256E+01, | A4 = −0.34442E−02, | A6 = 0.10763E−01, |
| A8 = −0.59391E−02, | A10 = 0.37082E−03 | |

Fourth surface

| | | |
|---|---|---|
| K = −0.17415E+02, | A4 = −0.23971E−01, | A6 = 0.19654E−01, |
| A8 = −0.88369E−02, | A10 = 0.11981E−02 | |

Fifth surface

| | | |
|---|---|---|
| K = −0.19173E+02, | A4 = −0.59634E−02, | A6 = 0.11854E−01, |
| A8 = −0.55652E−02, | A10 = 0.14173E−02, | A12 = −0.14817E−03 |

Sixth surface

| | | |
|---|---|---|
| K = 0.19634E+02, | A4 = −0.55092E−02, | A6 = 0.37558E−02, |
| A8 = −0.64978E−03, | A10 = 0.16145E−03, | A12 = −0.16946E−04 |

Seventh surface

| | | |
|---|---|---|
| K = −0.29973E+01, | A4 = −0.25718E−01, | A6 = 0.83725E−02, |
| A8 = −0.20725E−02, | A10 = 0.44531E−03, | A12 = −0.20066E−04 |

Eighth surface

| | | |
|---|---|---|
| K = −0.11658E+02, | A4 = −0.41840E−01, | A6 = −0.12657E−02, |
| A8 = 0.82939E−03, | A10 = −0.12381E−03, | A12 = 0.92004E−05 |

Ninth surface

| | | |
|---|---|---|
| K = −0.64839E+00, | A4 = −0.55582E−01, | A6 = 0.72567E−02, |
| A8 = −0.83289E−03, | A10 = 0.59449E−04, | A12 = −0.19144E−05 |

Single lens data of Example 4 is shown in Table 8 below.

TABLE 8

| | | Focal length |
|---|---|---|
| LENS | First surface | (mm) |
| 1 | 2 | 3.946 |
| 2 | 4 | −5.624 |
| 3 | 6 | 6.973 |
| 4 | 8 | −26.180 |

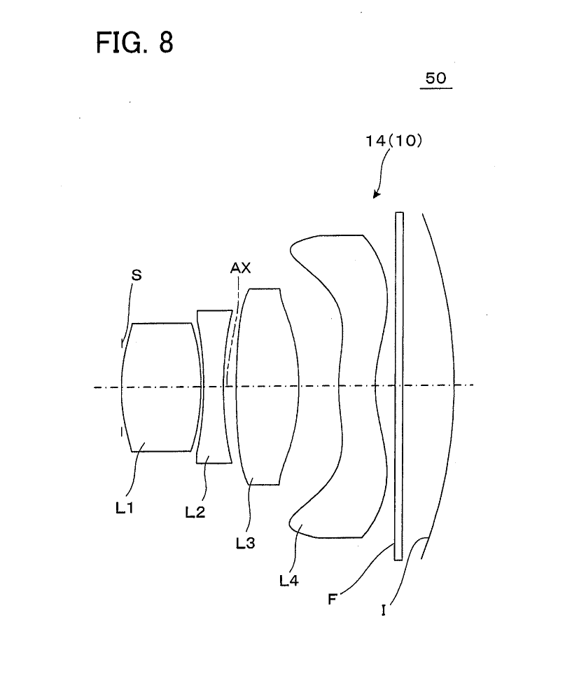

FIG. 8 is a sectional view of an image pickup lens 14 of Example 4 or the imaging unit 50. The image pickup lens 14 includes the first biconvex lens L1 having a positive refractive power, the second biconcave lens L2 having a negative refractive power, the third biconvex lens L3 having a positive refractive power, and a fourth meniscus lens L4 having a negative refractive power and convex toward the object side. All the lenses L1 to L4 are formed of plastic materials. On the object side of the first lens L1, the aperture stop S is disposed and between the exit side surface of the fourth lens L4 and the concave image pickup surface I, the parallel flat plate F, which is supposed to be an optical low pass filter, an IR cut filter, a seal glass of a solid-state image sensor, etc, is disposed. In the present example, the image pickup surface I has a spherical shape.

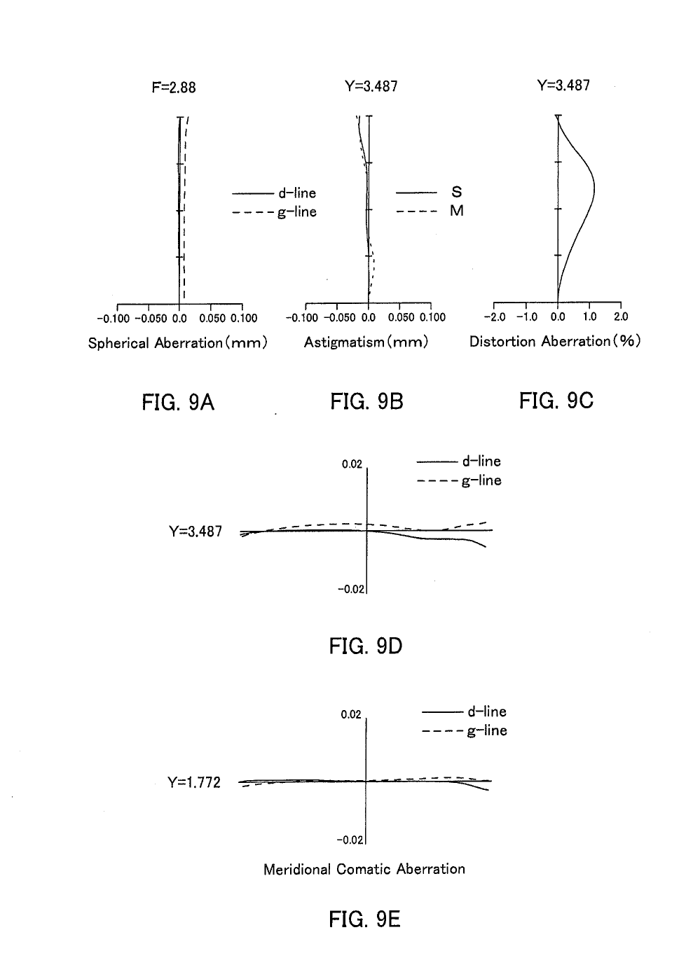

FIGS. 9A to 9C show aberration diagrams (spherical aberration, astigmatism, and distortion aberration) of the image pickup lens 14 of Example 4 and FIGS. 9D and 9E show the meridional comatic aberration of the image pickup lens 14 of Example 4.

### Example 5

General specifications of an image pickup lens of Example 5 are as follows.

f=3.52 mm
fB=1.04 mm

### F=2.8

### 2Y=5.744 mm

### ENTP=0 mm

### EXTP=−2.89 mm

### H1=0.37 mm

### H2=−2.4 8 mm

Lens surface data of Example 5 is shown in Table 9 below.

| Surface | | | | | Effective |
|---|---|---|---|---|---|
| number | R (mm) | D (mm) | Nd | vd | radius (mm) |
| 1 (STOP) | infinity | −0.05 | | | 0.67 |
| 2* | 2.379 | 0.98 | 1.54470 | 56.2 | 0.67 |
| 3* | −2.832 | 0.05 | | | 0.92 |
| 4* | −3.018 | 0.30 | 1.63200 | 23.4 | 0.94 |
| 5* | −235.830 | 0.27 | | | 1.07 |
| 6* | −28.219 | 0.71 | 1.54470 | 56.2 | 1.29 |
| 7* | −5.145 | 0.77 | | | 1.47 |
| 8* | 7.781 | 0.68 | 1.54470 | 56.2 | 1.95 |
| 9* | 8.171 | 1.04 | | | 2.34 |
| 10 (IMAG) | −5.000 | | | | |

Aspherical surface coefficients of the lens surfaces of Example
5 are as follow.

Second surface

K = −0.12146E+01, A4 = −0.12881E−01, A6 = −0.21281E−01,
A8 = 0.14977E−01, A10 = −0.45090E−01

Third surface

K = 0.77739E+01, A4 = −0.87252E−01, A6 = 0.12099E+00,
A8 = 0.10957E−01, A10 = −0.15074E−02

Fourth surface

K = 0.83353E+01, A4 = 0.60055E−02, A6 = 0.11417E+00,
A8 = 0.13321E−01, A10 = −0.64017E−02

Fifth surface

K = 0.50000E+02, A4 = 0.75714E−01, A6 = 0.26850E−01,
A8 = −0.37066E−01, A10 = 0.35778E−01, A12 = −0.15596E−01

Sixth surface

K = 0.46169E+02, A4 = −0.23820E−01, A6 = 0.29470E−01,
A8 = 0.66328E−02, A10 = −0.58642E−02, A12 = 0.79812E−03

Seventh surface

K = 0.35966E+01, A4 = −0.50298E−01, A6 = 0.32881E−01,
A8 = −0.89186E−02, A10 = 0.58415E−02, A12 = −0.12032E−02

Eighth surface

K = −0.50000E+2, A4 = −0.80417E−01, A6 = 0.42909E−02,
A8 = 0.57286E−02, A10 = −0.22401E−02, A12 = 0.27244E−03

Ninth surface

K = 0.10651E+02, A4 = −0.73689E−01, A6 = 0.14902E−01,
A8 = −0.29045E−02, A10 = 0.40555E−03, A12 = −0.36409E−04

Single lens data of Example 5 is shown in Table 10 below.

TABLE 10

| | | Focal length |
|---|---|---|
| LENS | First surface | (mm) |
| 1 | 2 | 2.543 |
| 2 | 4 | −4.840 |
| 3 | 6 | 11.426 |
| 4 | 8 | 185.132 |

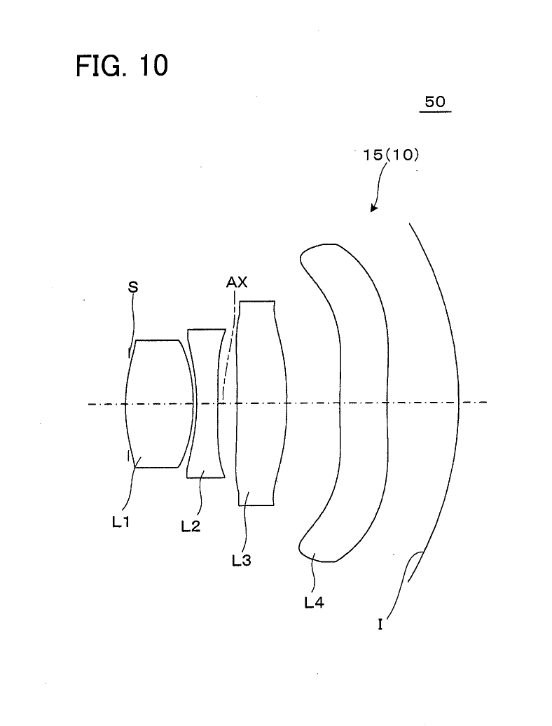

FIG. 10 is a sectional view of an image pickup lens 15 of Example 5 or the imaging unit 50. The image pickup lens 15 includes the first biconvex lens L1 having a positive refractive power, the second meniscus lens L2 having a negative refractive power and convex toward the image side, the third meniscus lens L3 having a positive refractive power and convex toward the image side, and the fourth meniscus lens L4 having a positive refractive power and convex toward the object side. All the lenses L1 to L4 are formed of plastic materials. On the object side of the first lens L1, the aperture stop S is disposed. In the present example, the image pickup surface I has a spherical shape. It is possible to dispose the parallel flat plate F shown in FIG. 1 between the concave surface (convex surface as a whole despite the concave surface near the axis) of the fourth lens L4 and the concave image pickup surface I.

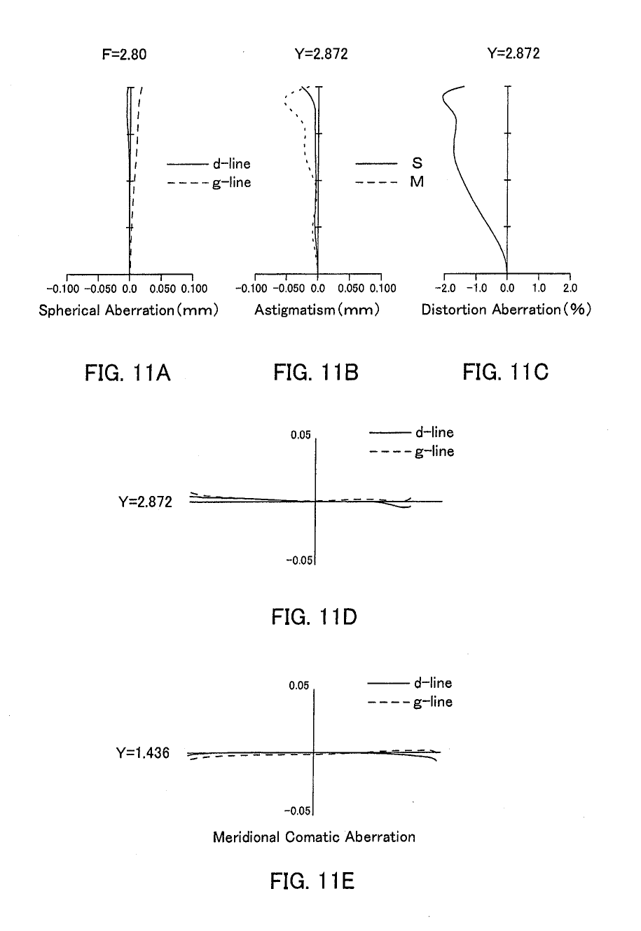

FIGS. 11A to 11C show aberration diagrams (spherical aberration, astigmatism, and distortion aberration) of the image pickup lens 15 of Example 5 and FIGS. 11D and 11E show the meridional comatic aberration of the image pickup lens 15 of Example 5.

### Example 6

General specifications of an image pickup lens of Example 6 are as follows.

f=0.84 mm
fB=0.21 mm

### F=2.8

### 2Y=2.8 mm

### ENTP=0 mm

### EXTP=0.55 mm

### H1=2.91 mm

### H2=−0.62 mm

Lens surface data of Example 6 is shown in Table 11 below.

TABLE 11

| Surface | | | | | Effective |
|---|---|---|---|---|---|
| number | R (mm) | D (mm) | Nd | vd | radius (mm) |
| 1 | infinity | 0.03 | | | 0.15 |
| (STOP) | | | | | |
| 2* | 8.706 | 0.61 | 1.54470 | 56.2 | 0.17 |
| 3* | −0.475 | 0.56 | | | 0.43 |
| 4* | −0.208 | 0.40 | 1.63200 | 23.4 | 0.55 |
| 5* | −0.168 | 0.20 | | | 0.90 |
| 6 | −5.000 | | | | |
| (IMAG) | | | | | |

Aspherical surface coefficients of the lens surfaces of Example
6 are as follow.
Second surface

| | | |
|---|---|---|
| K = −0.50000E+02, | A4 = −0.12682E+01, | A6 = −0.35486E+00, |
| A8 = −0.81899E+03, | A10 = 0.66115E+04, | A12 = 0.11990E+06 |

Third surface

| | | |
|---|---|---|
| K = −0.41158E−01, | A4 = 0.32348E+00, | A6 = 0.54040E−01, |
| A8 = 0.77066E+01, | A10 = 0.27183E+01, | A12 = −0.17606E+03 |

Fourth surface

| | | |
|---|---|---|
| K = −0.12097E+01, | A4 = 0.42911E+01, | A6 = −0.18903E+02, |
| A8 = 0.18472E+02, | A10 = 0.98577E+02, | A12 = −0.29747E+03 |

Fifth surface

| | | |
|---|---|---|
| K = −0.19116E+01, | A4 = 0.16313E+01, | A6 = −0.32529E+01, |
| A8 = 0.38040E+01, | A10 = −0.27783E+01, | A12 = 0.93624E+00 |

Single lens data of Example 6 is shown in Table 12 below.

TABLE 12

| | | Focal length |
|---|---|---|
| LENS | First surface | (mm) |
| 1 | 2 | 0.846 |
| 2 | 4 | 0.283 |

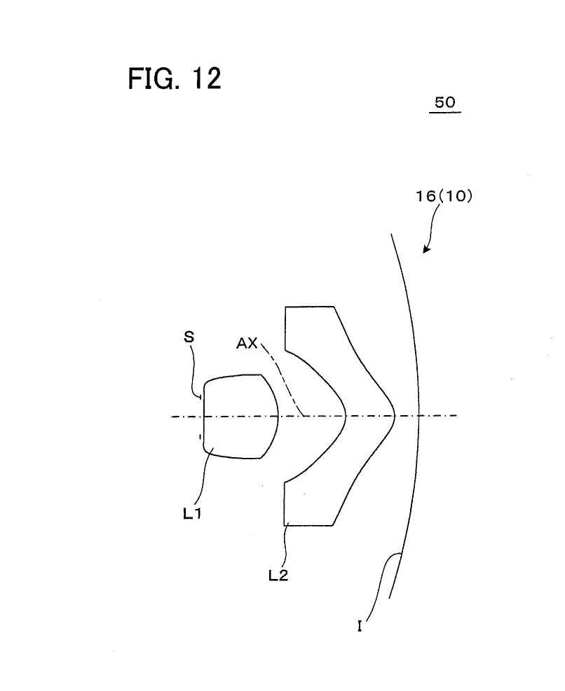

FIG. 12 is a sectional view of an image pickup lens 16 of Example 6 or the imaging unit 50. The image pickup lens 16 includes the first biconvex lens L1 having a positive refractive power and the second meniscus lens L2 having a positive refractive power and convex toward the image side. All the lenses L1 and L2 are formed of plastic materials. On the object side of the first lens L1, the aperture stop S is disposed. In the present example, the image pickup surface I has a spherical shape. It is possible to dispose the parallel flat plate F shown in FIG. 1 between the convex surface of the second lens L2 and the concave image pickup surface I.

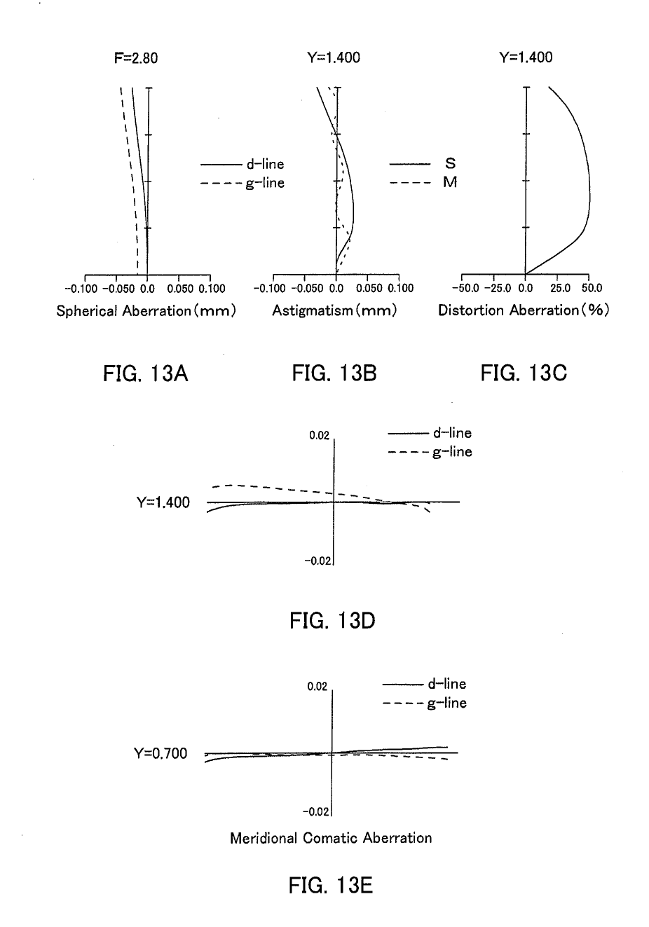

FIGS. 13A to 13C show aberration diagrams (spherical aberration, astigmatism, and distortion aberration) of the image pickup lens 16 of Example 6 and FIGS. 13D and 13E show the meridional comatic aberration of the image pickup lens 16 of Example 6.

### Example 7

General specifications of an image pickup lens of Example 7 are as follows.

f=0.84 mm
fB=0.99 mm

### F=2.8

### 2Y=3 mm

### ENTP=1.19 mm

### EXTP=−1.44 mm

### H1=1.74 mm

### H2=0.16 mm

Lens surface data of Example 7 is shown in Table 13 below.

TABLE 13

| Surface | | | | | Effective |
|---|---|---|---|---|---|
| number | R (mm) | D (mm) | Nd | vd | radius (mm) |
| 1* | 1.702 | 0.40 | 1.72920 | 54.7 | 1.64 |
| 2* | 0.597 | 1.02 | | | 1.02 |
| 3* | 1.605 | 0.83 | 1.84670 | 23.8 | 0.76 |
| 4* | 2.736 | 0.08 | | | 0.32 |
| 5(STOP) | infinity | 0.09 | | | 0.23 |
| 6* | 1.973 | 0.88 | 1.58910 | 61.1 | 0.39 |
| 7* | −0.525 | 0.05 | | | 0.61 |
| 8* | −1.511 | 0.35 | 1.84670 | 23.8 | 0.63 |
| 9* | −6.628 | 0.99 | | | 0.93 |
| 10 (IMAG) | −10.000 | | | | |

Aspherical surface coefficients of the lens surfaces of Example
7 are as follow.

First surface

K = −0.19685E+01, A4 = 0.41315E−01, A6 = −0.42606E−01,
A8 = −0.21322E−02, A10 = 0.60628E−02, A12 = −0.99529E−03

Second surface

K = −0.83050E+00, A4 = 0.37019E−01, A6 = −0.33652E−01,
A8 = −0.59534E+00, A10 = 0.30779E+00, A12 = 0.66336E−01

Third surface

K = 0.23986E+01, A4 = −0.16324E+00, A6 = 0.75684E+00,
A8 = −0.31843E+01, A10 = 0.56471E+01, A12 = −0.35225E+01

Fourth surface

K = −0.17897E+02, A4 = 0.69636E+00, A6 = −0.41079E+01,
A8 = 0.55261E+02, A10 = −0.14580E+03

Sixth surface

K = 0.49674E+01, A4 = 0.88013E−01, A6 = −0.78245E+00,
A8 = 0.27750E+01, A10 = 0.42642E+00

Seventh surface

K = −0.64733E+00, A4 = 0.12551E+01, A6 = −0.72027E+01,
A8 = 0.37169E+02, A10 = −0.10538E+03, A12 = 0.11507E+03

Eighth surface

K = −0.22819E+02, A4 = −0.54575E+00, A6 = −0.38032E+00,
A8 = 0.18040E+01, A10 = −0.29671E+01, A12 = −0.16462E+02

Ninth surface

K = 0.46532E+02, A4 = −0.12441E+00, A6 = 0.43294E+00
A8 = −0.10241E+01, A10 = 0.68322E+00, A12 = −0.13325E+00

Single lens data of Example 7 is shown in Table 14 below.

TABLE 14

| | | Focal length |
|---|---|---|
| LENS | First surface | (mm) |
| 1 | 1 | −1.487 |
| 2 | 3 | 3.434 |
| 3 | 6 | 0.810 |
| 4 | 8 | −2.387 |

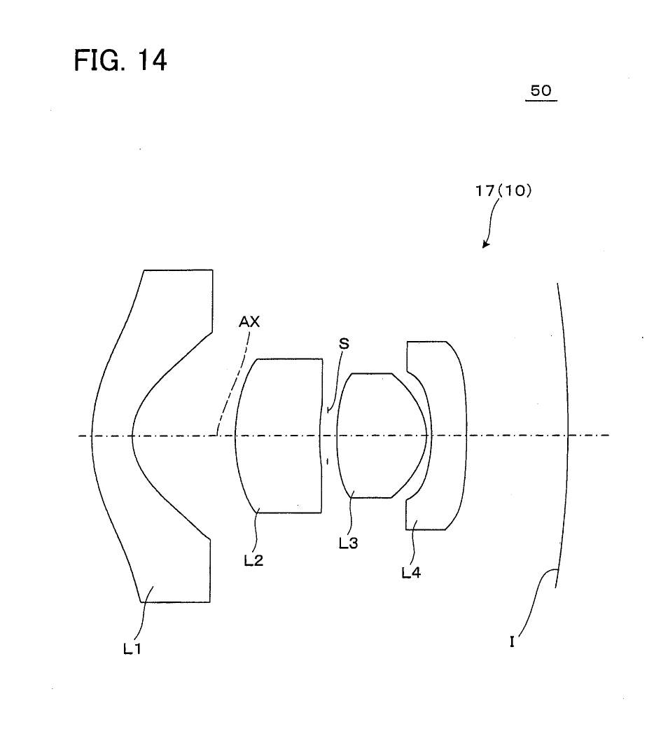

FIG. 14 is a sectional view of an image pickup lens 17 of Example 7 or the imaging unit 50. The image pickup lens 17 includes the first meniscus lens L1 having a negative refractive power and convex toward the object side, the second meniscus lens L2 having a positive refractive power and convex toward the object side, the third biconvex lens L3 having a positive refractive power, and the fourth meniscus lens L4 having a negative refractive power and convex toward the image side. All the lenses L1 to L4 are formed of plastic materials. Between the second lens L2 and the third lens L3, the aperture stop S is disposed. In the present example, the image pickup surface I has a spherical shape. It is possible to dispose the parallel flat plate F shown in FIG. 1 between the convex surface of the second lens L2 and the concave image pickup surface I.

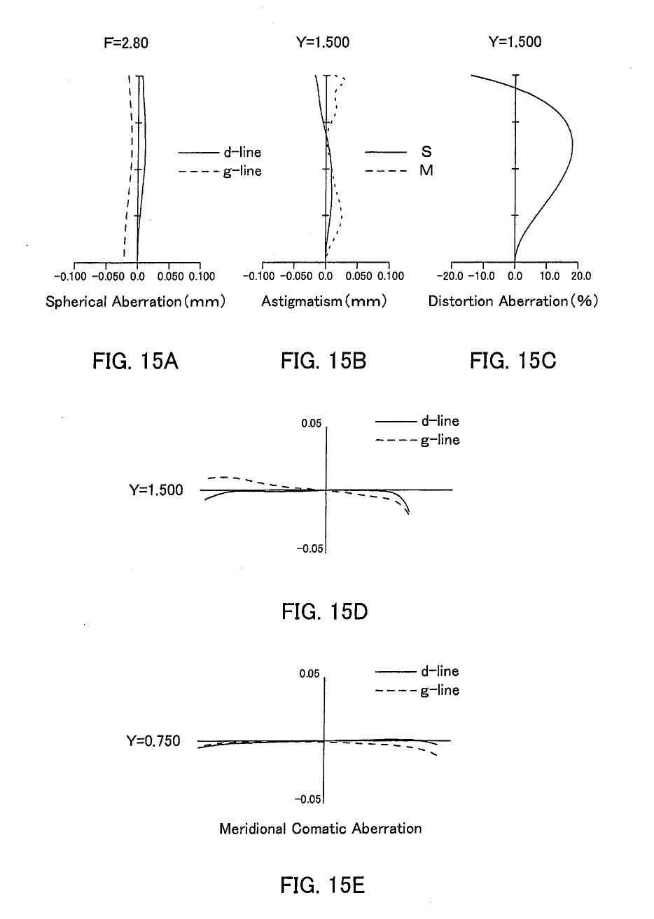

FIGS. 15A to 15C show aberration diagrams (spherical aberration, astigmatism, and distortion aberration) of the image pickup lens 17 of Example 7 and FIGS. 15D and 15E show the meridional comatic aberration of the image pickup lens 17 of Example 7.

Table 15 below summarizes the values of each of Examples 1 to 7 corresponding to each of the conditional expressions (1) to (4) for reference.

TABLE 15

| Conditional | | | | | | | | |
|---|---|---|---|---|---|---|---|---|
| expression | | Example 1 | Example 2 | Example 3 | Example 4 | Example 5 | Example 6 | Example 7 |
| (1) | THID/THIC | 1.16 | 1.14 | 0.88 | 1.70 | 0.89 | 1.20 | 1.32 |
| (2) | SAGI/Y | 0.14 | 0.13 | 0.17 | 0.18 | 0.32 | 0.14 | 0.08 |
| (3) | RI/Y | −3.63 | −3.98 | −3.04 | −2.82 | −1.74 | −3.57 | −6.67 |
| (4) | SAGI/SAGL | 0.65 | 0.91 | 2.37 | 10.31 | 1.19 | 0.42 | 0.54 |
| (5) | fB/f | 0.32 | 0.25 | 0.57 | 0.33 | 0.29 | 0.25 | 1.18 |

With regard to the meaning of the paraxial radius of curvature described in the claims and Examples, in the actual lens measurement, it is possible to regard or assume an approximate radius of curvature which is fitted to the shape measurements in the vicinity of the lens center (specifically, the central area of 10% or less of the lens outer diameter) by the least squares method, as the paraxial radius of curvature.

Further, for example, in the case where the second order aspherical coefficients are used, it is possible to regard the radius of curvature that has also taken into consideration the second order aspherical surface coefficients in addition to the reference radius of curvature of the definitional equation of the aspherical surface, as the paraxial radius of curvature (as a reference document, for example, see P41 to 42 of “Lens Designing Method” by Yoshiya Matsui (KYORITSU SHUPPAN CO., LTD.))

The image pickup lenses 11 to 17 in Examples described above are configured by two to four lenses of the lenses L1, L2 (L3, and L4), but, it is possible to add one or more lenses having substantially no power before, after, or between the lenses L1, L2 (L3, and L4).

1. An image pickup lens for forming a subject image on a solid-state image sensor, in which an image pickup surface of said solid-state image sensor is curved so as to tilt toward an object side in an arbitrary cross-section toward a periphery of an image area, the image pickup lens comprising
two or more lenses, wherein
the image pickup lens has an aperture stop in a position other than positions between a lens nearest to an image side and the solid-state image sensor,
an image side surface of said lens nearest to the image side has an aspherical shape, and
a conditional expression below is satisfied
0.80<THID/THIC<2.00 (1)
where
THID: a thickness of an outermost periphery of said lens nearest to the image side along an optical axis direction
THIC: a thickness on an optical axis of said lens nearest to the image side.

2. The image pickup lens according to claim 1, wherein
said image pickup surface satisfies a conditional expression below
0.05<SAGI/Y<0.50 (2)
where
SAGI: an amount of displacement of said image pickup surface in the optical axis direction at a maximum image height
Y: a maximum image height.

3. The image pickup lens according to claim 1, wherein
said image pickup surface has a spherical shape and satisfies a conditional expression below
−8.0<RI/Y<−1.0 (3)
where
RI: a radius of curvature of said image pickup surface
Y: a maximum image height.

4. The image pickup lens according to claim 1, wherein
a conditional expression below is satisfied
0.30<SAGI/SAGL<10.50 (4)
where
SAGI: an amount of displacement of said image pickup surface in the optical axis direction at a maximum image height
SAGL: an amount of displacement of the image side surface of said lens nearest to the image side from the optical axis in a maximum effective aperture.

5. The image pickup lens according to claim 1, wherein
said lens nearest to the image side has a negative refractive power.

6. The image pickup lens according to claim 1, wherein
a conditional expression below is satisfied
0.15<fb/f<1.30 (5)
where
fb: a back focus of the image pickup lens
f: a focal length of an entire system of the image pickup lens.

7. The image pickup lens according to claim 1, wherein
the aperture stop is disposed on an object side of the two or more lenses constituting said image pickup lens.

8. The image pickup lens according to claim 1, wherein
the aperture stop is disposed between a first lens on a side nearest to the object and a second lens adjacent to an image side of said first lens of the two or more lenses constituting said image pickup lens.

9. The image pickup lens according to claim 1, further comprising a lens having substantially no power.

10. An image pickup device comprising the image pickup lens according to claim 1 and said solid-state image sensor.
